(19) United States
(12) Patent Application Publication
(10) Pub. No.: US 2007/0050701 A1
(43) Pub. Date: Mar. 1, 2007

(54) Method, system and computer program product for medical form creation

(76) Inventors: Khaled El Emam, Ottawa (CA); Jonathan Fortye Bermingham Barker, Ottawa (CA); Nadil Punjani, Ottawa (CA); Hua Li, Kanata (CA); Ian Stefanison, Ottawa (CA); Suleiman Jabbouri, Ottawa (CA)

Correspondence Address: CONLEY ROSE, P.C., P. O. BOX 3267, HOUSTON, TX, 77253-3267, US

(21) Appl. No.: 11/216,551

(22) Filed: Aug. 31, 2005

(51) Int. Cl. G06F 17/00; G06F 19/00

(52) U.S. Cl. 715/505; 705/3

(57) ABSTRACT

A method, system and computer program product for medical form creation are disclosed. The computer program product has a computer readable medium storing medical form software that provides a user interface. The medical form software includes computer executable instructions for creating at least partially non-completed medical forms. Each of the medical forms is defined at least in part by a plurality of operands. A number of the operands are modifiable upon form completion by a form completing entity. The medical form software also includes computer executable instructions for building, within the user interface, conditional responses to potential future events occurring in relation to the medical forms.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The present invention relates to electronic medical forms and, in particular, to a method, system and computer program product for medical form creation.

### BACKGROUND OF THE INVENTION

Forms, whether paper or electronic, are used in the collection of data. The creation and management of forms used in medical activities is known for being costly and consuming considerable human resources. In previously known electronic form management techniques, changing electronic forms typically entailed hand-editing html and JavaScript® code, updating a database schema, recoding electronic handheld information device software, and having sites update their installed software.

### BRIEF SUMMARY

According to one example of the invention is a computer program product having a computer readable medium storing medical form software that provides a user interface. The medical form software includes computer executable instructions for creating at least partially non-completed medical forms. Each of the medical forms is defined at least in part by a plurality of operands. A number of the operands are modifiable upon form completion by a form completing entity. The medical form software also includes computer executable instructions for building, within the user interface, conditional responses to potential future events occurring in relation to the medical forms.

According to another example of the invention is a method carried out on a computer system having at least one user input device and at least one computer readable medium storing medical form software. The method includes the step of operating the at least one user input device to generate a plurality of commands recognized by the software to create at least partially non-completed medical forms. Each of the medical forms is defined at least in part by a plurality of operands. A number of the operands are modifiable upon form completion by a form completing entity. The method also includes the step of building, within the user interface, conditional responses to potential future events occurring in relation to the medical forms.

The term “entity” as used herein primarily refers to a person, but the term could have a broader meaning within the context in which it is used if so understood by one skilled in the art.

Other aspects and features of the present invention will be apparent to those of ordinary skill in the art from a review of the following detailed description when considered in conjunction with the drawings.

### BRIEF DESCRIPTION OF THE DRAWINGS

Reference will now be made, by way of example, to the accompanying drawings which show example embodiments of the present invention, and in which:

FIG. 1 is a screen shot of an example form manager page;

FIG. 2 is a screen shot of another example form manager page;

FIG. 3 is a screen shot of an example page within which a Demographics form can be modified;

FIG. 4 is a screen shot of an example page within which a question for a form can be created;

FIG. 5 shows a table listing medication-related information;

FIG. 6 is a screen shot of a page similar to the page of FIG. 4, the illustrated page configured to create a hidden question associated with a slider bar image;

FIG. 7 is a screen shot of a page similar to the page of FIG. 4, the page configured to create a question that will contain the slider bar image;

FIG. 8 is a screen shot of an example page for uploading and connecting the slider bar image;

FIG. 9 is a screen shot of an example page for event response creation;

FIG. 10 is a screen shot of a portion of a page similar to the page of FIG. 9, but substantially completed;

FIG. 11 is a screen shot of an example page within which an example query is being built;

FIG. 12 is a screen shot of an example page within which a form-related formula is being built; and

FIG. 13 is a screen shot of an example page within which a Medications form is being added to multiple visits across multiple groups.

Similar reference numerals may have been used in different figures to denote similar components.

### DESCRIPTION OF EXAMPLE EMBODIMENTS

Most data obtained through medical forms is capable of being organized into categories. Often the relationship between a number of categories will be hierarchical. As an example, at the top level of a categorization hierarchy might be center categorization, then in descending level order, group, subject, visit, and form categorizations.

With respect to the center level of this example hierarchy, this might refer to one or more possible physical locations. A center could be a city, hospital, clinic, or other type of center as appropriate. In some situations, there will be one or more specific people in charge of overseeing all of the patients for a particular center and the related data.

With respect to the group level, this level between the center and subject levels can conveniently permit breaking down the center category(s) into subcategories. For example, groups could refer to specific disease groups. The particular disease group in which a patient might fall could dictate the types of questions or forms that a patient might be required to answer (depending on their specific illness).

With respect to the subject level, this might refer to individual patients. Subjects might also refer to other types of individuals, such as doctors or nurses. In these cases, data collected in relation to a “subject” would likely be something other than patient date (e.g. it could be billable time data). Where there is a center and group level above the subject level, the hierarchy is such that each subject is associated with a particular center and group.

With respect to the visit level, this might refer to one or more visits that a subject might make to a particular center. In the context of non-patient subjects, a visit might refer to a period of time for the purposes of billing (e.g. a day, week, or even a month).

With respect to the form level, a form refers to a subject related form that is adapted to be completed. A form might contain a list of questions to be asked of the subject, within the appropriate visit. A demographics form, a blood work form, an adverse events form, a doctor's timesheet form, and a nurse's timesheet form are just some examples of possible forms.

Thus, the relationship between the above example center, group, subject, visit and form categories is hierarchical. These particular categories might be suitable when data is being collected in relation to a clinical trial. Other, additional and/or fewer categories might be suitable for other medical data collection activities.

In some embodiments of the presently disclosed medical form software, a form designer tool of the medical form software allows a software user to perform actions within a user interface of the medical form software, these actions including creating, modifying, copying, previewing, ordering (order of presentation to a form completing entity), and deleting forms within a particular project. The medical form software can also include a number of tools allowing the content of forms to be managed, including questions, answers, event responses, formulas, and export data.

Within the user interface of some embodiments of the presently disclosed medical form software, user input from user devices of the computer system of the user effect addition and modification of content within user interface pages, which are used to generate, for example, a plurality of commands recognized by the medical form software to create at least partially non-completed medical forms.

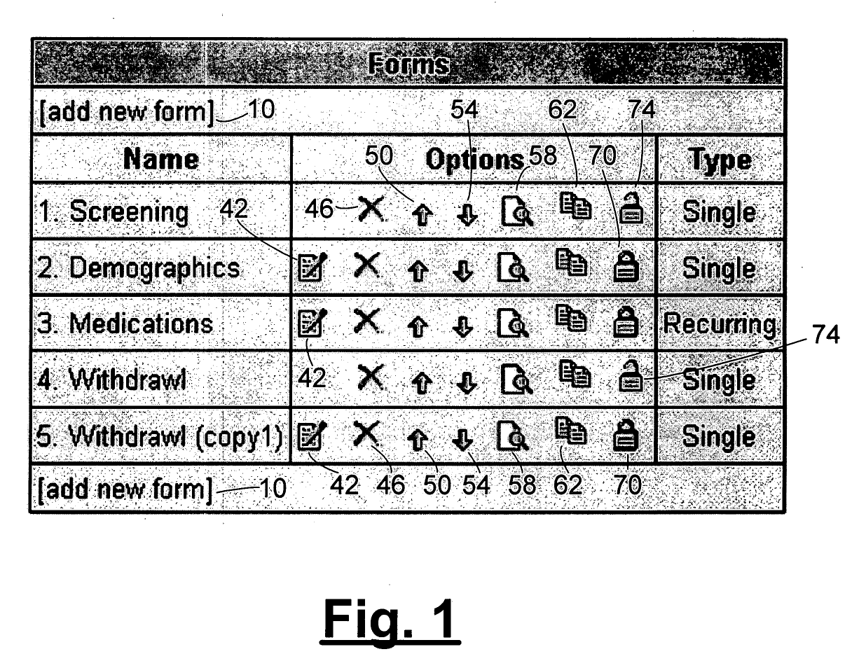

FIG. 1 is a screen shot of an example form manager page of the form designer tool. Within the example page, a number of forms are listed. As will be appreciated by one skilled in the art, most electronic medical forms of the type disclosed herein are defined at least in part by a plurality of operands, with a number of these operands modifiable upon form completion by the form completing entity.

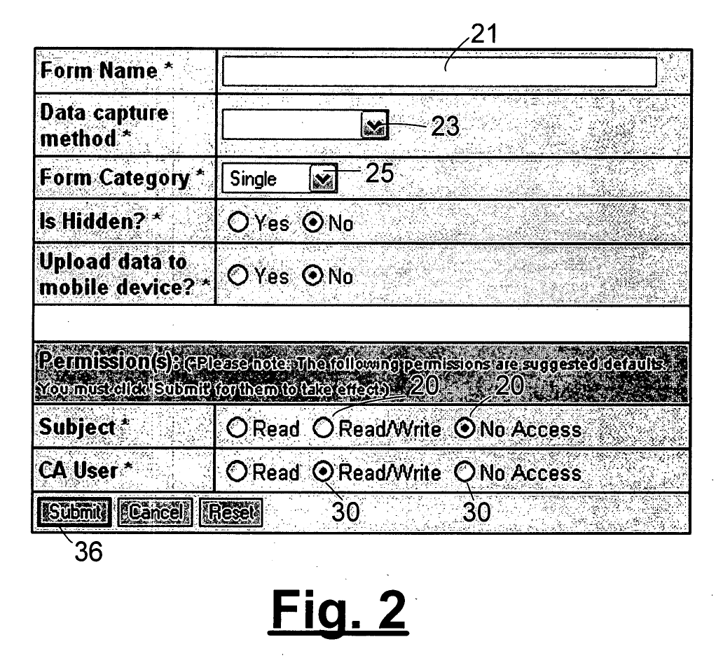

By clicking on ‘[add a new form]’ selection 10 at either the top or bottom of the listing of forms, a new medical form can be created. This brings the software user to a page of the form designer tool within which form attributes can be set and modified. An example of such a page is illustrated in the screen shot of FIG. 2.

The software user can enter text in text field 21 of the illustrated page. This text is the name of the form as it will appear to form completing entities. Also, drop-down selector 23 of the illustrated page permits selection of the ways in which the form will be made available for form completion (e.g. web only, mobile device only, web and telephone, web and mobile device, etc.).

### FORM CATEGORIES

In some embodiments, one way in which a form can be categorized is by whether the form is ‘Single’, ‘Recurring’ or “OnGoing’.

| Form Category | Description |
|---|---|
| Single | The form is set so that it can only be edited once per visit. |
| Recurring | The form is set so that it can be filled out multiple times in one visit. |
| | This type of form would be useful, for example, with a form involving |
| | medications: If there were 20 separate medications that a patient is taking |
| | with 10 questions per medication, a ‘Single’ form would have to have 200 |
| | questions (10 questions for each medication). However, a ‘Recurring’ form |
| | could have 1 question asking which medication the person is entering data |
| | for followed by the 10 questions that would be asked for it. This way a |
| | user could enter a new form for each of the medications that data must be |
| | entered for. Also, a table could be displayed showing the entry of each |
| | form throughout all visits when viewing or editing new forms. |
| OnGoing | OnGoing forms are set so that they are available across all visits that the |
| | form has been assigned to. |
| | For example, an OnGoing form filled out in the first visit will also be |
| | available to view or edit in every other visit that the form has been assigned |
| | to. In one embodiment, a table is displayed showing the entry of each form |
| | throughout all visits when viewing or editing new forms. An OnGoing |
| | form may be particularly useful for forms where some of the data may not |
| | become available until later in time (i.e. a medication has been started at |
| | visit ‘1’ so a Start Date is entered. However, at visit ‘10’ the medication is |
| | stopped. Rather than going back to visit 1 to enter a stop date, it can be |
| | entered at visit 10 as the previously filled form is available at visit 10. |

With respect to the page shown in FIG. 2, the form category is chosen using drop-down selector 25.

### ACCESS PERMISSIONS

Access to forms can be controlled by setting the appropriate permissions. Within the page illustrated in FIG. 2, permission for the subject can be set by clicking on one of the radio buttons 20. Permission for an entity referred to as “CA User” can be set by clicking on one of the radio buttons 30. A CA User could be an individual, such as a nurse, responsible for the data of multiple subjects.

For those embodiments for which there are centers, the permission setting will normally work in conjunction with center access levels: CA Users that do not have permission to perform a function within their center access level will not have these permissions overridden by permissions allowed using this setting. For example, if a form permission is set to allow Read/Write access for a CA User, this only affects the user if they would normally have Read AND Write permissions at the center level. For example, a CA User with “Observer” access at a center would not be able to enter or edit data in a form even if “Read/Write” access permissions for the form are enabled. A CA User with “Regular” access at a center level will not be allowed to enter or edit data if only “Read” permissions for the form are enabled even though their center level access level would normally allow this functionality. If “No Access” is selected, the form will not be displayed regardless of the access of the CA User at the center level.

In some embodiments, access level permission choices are as follows:

| Access Permission | Description |
|---|---|
| Read | The form may only be viewed and not entered or |
| | edited by the entity having this access level. |
| Read/Write | The form may be viewed, entered or edited by |
| | the entity having this access level. |
| No Access | The form will not be visible or accessible |
| | for the entity having this access level. |

In the example shown in FIG. 2, the software user finishes creating the new form by clicking ‘Submit’ button 36. As will be appreciated by one skilled in the art, this corresponds to storing the entered information in a more permanent form, for example, in structure storage means on a hard disk.

It will be understood that it might be practical for the order in which the forms appear in the form designer tool to dictate the order in which they are displayed when entering form data within the visit. Referring to FIG. 1 as an example, the “Screening” form might be presented first to the form completing entity, then the “Demographics” form, etc.

### FORM MANAGING OPTIONS

Buttons within the page shown in FIG. 1 allow the software user to perform actions on the forms. A form can be modified by clicking one of buttons 42 if a closed padlock icon is shown. A form can be deleted by clicking one of buttons 46. A form can be moved up or down in the list of forms by clicking one of buttons 50 or one of buttons 54 respectively. A form can be previewed by clicking one of buttons 58. A copy of a form can by made by clicking one of buttons 62.

### COPYING A FORM

In one embodiment, all questions and answers will be copied to a new form that will appear in the list of forms when the copying of a form is carried out. Also, it may be practical if events and formulas are not copied to the new form. As an example, if the software user were to click on the copy button 62 for ‘Withdrawal’ form, a copy would appear as a new form ‘Withdrawal (copy1)’ (which could be renamed if desired).

It will be understood that the copied form may contain an exact copy of the export headers and descriptions from the original form. If so, the export headers for each question should be changed to avoid duplicate headers existing within the database preventing exporting of the project.

### UNFROZEN/FROZEN FORM

An “unfrozen” form can be “frozen” by clicking one of the closed padlock icons 70. This is normally done when the form is ready to be made available for form completion. For the illustrated form designer tool, freezing a form will cause the associated modify (edit) button 42 to disappear.

In one embodiment, freezing a form does two things:

1. The form can no longer be modified using the form designer tool. For this reason, the edit button 42 can conveniently disappear when a form is frozen.

2. The form will become available in the visits so that data can be entered.

A frozen form can be unfrozen by clicking one of the open padlock icons 74. For the illustrated form designer tool, unfreezing a form will cause an edit button 42 (associated with the form) to appear.

In one embodiment, unfreezing a form does two things:

1. The form becomes available for modification using the form designer tool. For this reason, the edit button 42 can conveniently appear.

2. The form will not be available for data entry. This ensures that data cannot be entered in a form that is being modified.

### MODIFYING FORMS

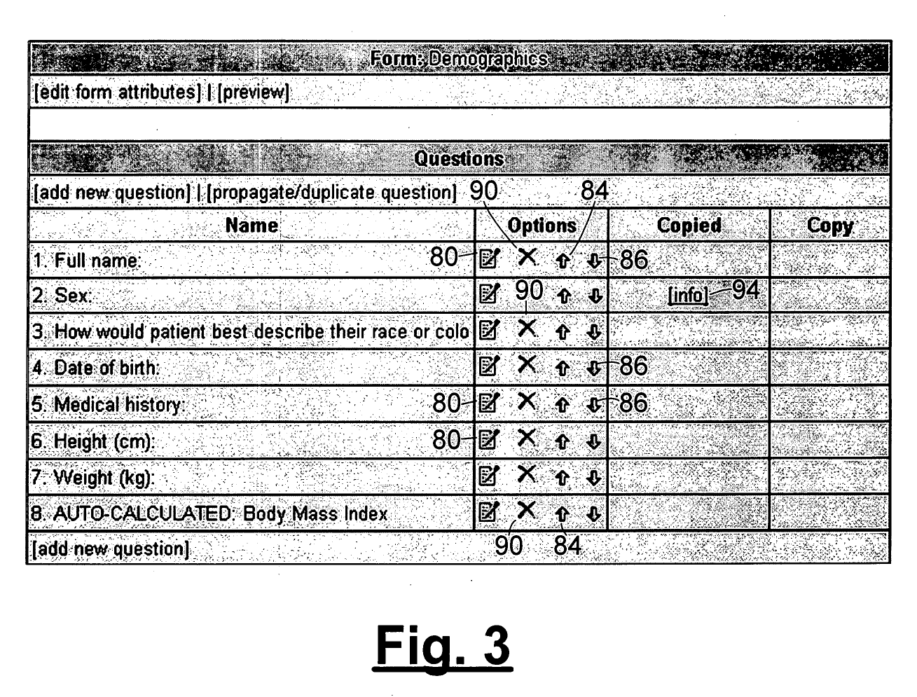

FIG. 3 is a screen shot of an example page of the form designer tool which could be presented after the software user clicks on the edit button 42 associated with the form “Demographics”. Through the page that is illustrated, the software user can modify form attributes, questions, events and formulas.

In the illustrated page, buttons provided in the ‘Options’ column allow the software user to perform actions on a question, namely the following: modify a question by clicking one of buttons 80; order a question by moving it up or down in the list of questions by clicking one of buttons 84 or buttons 86 respectively; and delete a question by clicking one of buttons 90.

As will be subsequently explained, with respect to those embodiments in which questions that propagate values to other forms are possible, the propagating questions are set so that they cannot be deleted until all destination questions have first been deleted. For this reason, source questions (indicated, for example, by an ‘[info]’ link 94 appearing in the Copied column) will not have the delete button 90 available.

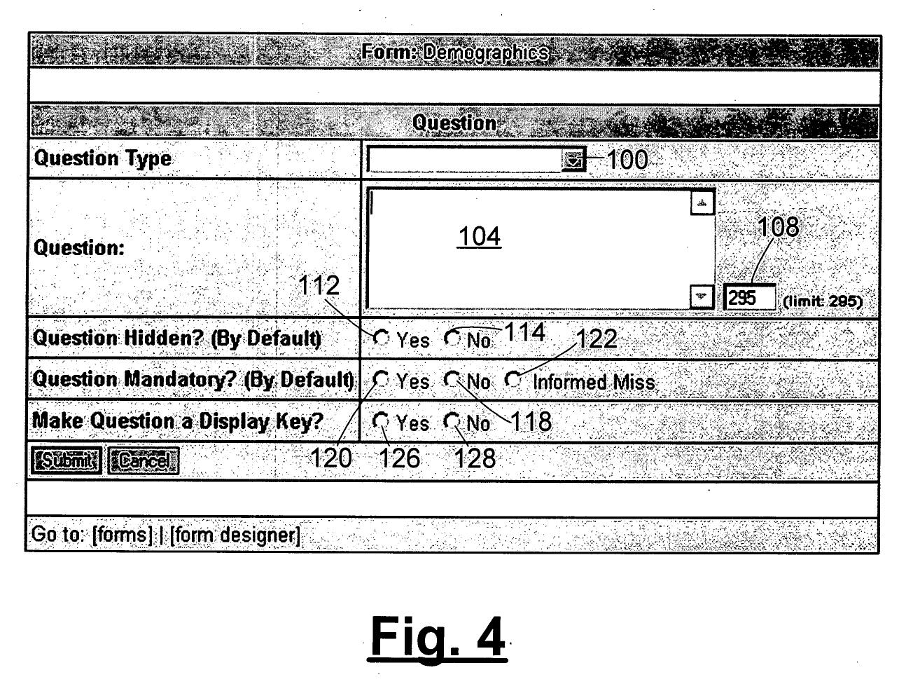

In the illustrated example, the software user adds a question to the form by clicking on ‘[add a new question]’ at the top or bottom of the page, and a new page is presented allowing the software user to modify the attributes of the new question. A screen shot illustrating this new page in accordance with an example embodiment is shown in FIG. 4.

By clicking on drop-down selector 100, the software user can select the type of question that will best capture the intended data. Possible question types include the following:

| Question Type | Description |
|---|---|
| Single Answer | Allows the form completing entity to select a single answer to a |
| | question by means of, for example, radio buttons. A good example of |
| | a single answer type question is one that asks for the sex of the form |
| | completing entity. |
| Multiple Answer | Allows the form completing entity to select a plurality of answers to a |
| | question by means of, for example, check boxes. A multiple answer |
| | type question is inappropriate where each of the answers are mutually |
| | exclusive of each other. |
| Numeric Answer | Allows the form completing entity to input a number only. An |
| | example of a numeric answer type question is one that asks for the |
| | height of the form completing entity. |
| Short Text Answer | Allows the form completing entity to input up to, for example, 99 |
| | characters of text. A good example of a short text answer type |
| | question is one that asks for the name of the form completing entity. |
| Long Text Answer | Allows the form completing entity to input up to, for example, |
| | 100,000 characters of text. This type of question would be used |
| | when an answer exceeding, for example, 99 characters of text might |
| | be required. |
| Date | Allows the form completing entity to input a date. The form |
| | completing entity uses, for example, three drop-down selectors to |
| | provide an answer. |
| DateTime | Allows the form completing entity to input date and time. |
| Time | Allows the form completing entity to input a time. The form |
| | completing entity uses, for example, two drop-down selectors, one |
| | for hour and one for minute, to provide an answer. |
| Header | Allows the entry of a header for display purposes only. For this type |
| | of “question” the form completing entity does not provide input. |
| Group Type | When this type of question is selected, the full description of the |
| | group for the current subject will automatically be inserted into the |
| | answer box. For example, if the subject 01-01-LK-01 who belongs to |
| | the “Leukemia” group is currently entering a form, the text |
| | “Leukemia” will automatically appear in the associated text answer |
| | box. |
| Visit Type | When this type of question is selected, the full description of the visit |
| | for the current subject will automatically be inserted into the answer |
| | box. For example, if the subject 01-01-LK-01 who is currently |
| | entering a form for the “Baseline” visit, the text “Baseline” will |
| | automatically appear in the associated text answer box. |
| Image Embedded | Allows the form completing entity to select an answer by clicking on |
| Answers | a region in an image. A good example of when image embedded |
| | answers would be appropriate is where the answer falls in a range. In |
| | this case, a slider bar could be used. |
| ReadOnly Comment | Allows the entry of a comment for display purposes only. |

In text field 104 of the illustrated page, the software user can enter the question text (up to a certain character limit) that is going to be asked. It will appear word-for-word in the form as entered here.

Box 108 to the right of the text field 104 helps the software user keep track of how many more characters they may enter as they type. The limit is approached when the number in the box 108 approaches zero.

The software user can choose whether the question will be seen when the form is first loaded by clicking on either ‘Yes’ or ‘No’ radio button 112 or 114 respectively. This option is in contemplation of situations in which it is desired to have one or more calculated-fields that are not visible to users, or where there are questions that may (as event responses) be shown as the form is filled out.

The software user can choose whether the question will be Optional, Mandatory or Informed Miss when the form is first loaded by clicking either radio button 118, 120 or 122 respectively. (It will be understood that this setting could be subject to change by events as the form is filled out.)

The possible selections are explained below.

| Selection | Description |
|---|---|
| No (Optional) | If selected, the question is optional by default. The form completing |
| | entity can submit the form without entering a response to the question. |
| Yes (Mandatory) | If selected, the question is mandatory by default. The form completing |
| | entity is required to enter a response to the form. If the field is left black |
| | when the form completing entity submits the form, the question will, for |
| | example, be highlighted in red with a pop-up message appearing stating |
| | the question was left blank and an answer is required. When a mandatory |
| | answer is required, there can be some form of indication on the form to |
| | this effect, such as a red asterisk next to the question. |
| Informed Miss | If selected, the question is optional by default. However, if the form |
| | completing entity does not enter an answer, before proceeding to submit |
| | a form, the question will, for example, be highlighted in green with a |
| | pop-up message appearing asking confirmation as to whether the form |
| | completing entity wishes the answer to be left blank. There could then be |
| | the opportunity to return to the form to answer the question, or continue |
| | with submission. Also, there can be some form of indication on a form |
| | that a particular question is going to be handled as informed missed. For |
| | example, there could be a green asterisk next to the question. |

In one embodiment, the functionality of making a question a display key is applicable to Recurring or OnGoing forms only. This functionality allows the software user to define which columns of data will be displayed from each form when viewing/editing responses to forms.

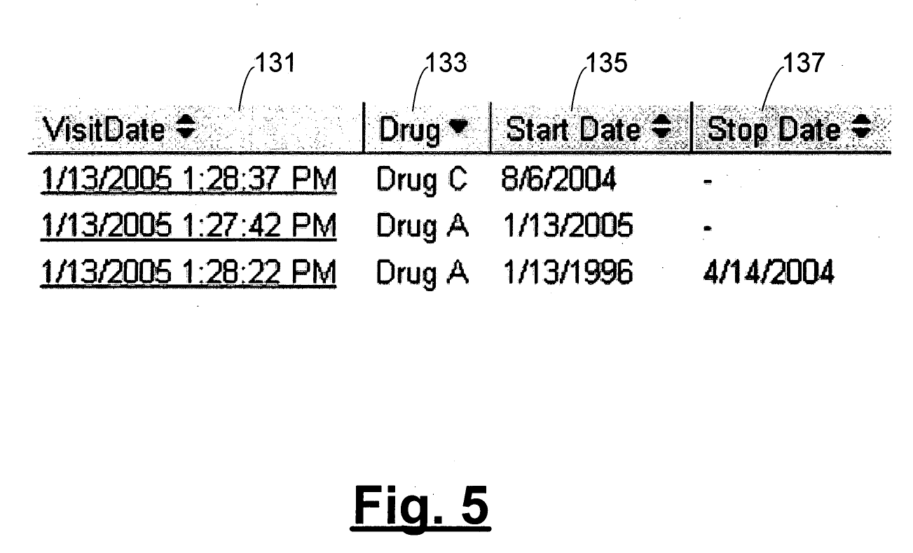

For example, a “Medication” form might perhaps have 6 questions. However, in many cases a Stop Date may not yet be available. In this case it may be desirable, for example, to see only three specified columns when the forms are viewed/edited: Drug Name, Stop Date and Start Date columns. Displaying only the relevant information may have the effect of permitting faster visual determination of whether there is a need to ask the patient if they have stopped the medication, and enter the information if necessary. The table of FIG. 5 corresponds to a form that has been filled out three times. The software can be set so that there will always be a VisitDate column 131 in the table. The example table also includes Drug Name column 133, Start Date column 135 and Stop Date column 137.

For the page illustrated in FIG. 4, the software user makes a question a Display Key by selecting ‘Yes’ radio button 126 instead of ‘No’ radio button 128. In response, a new row in the illustrated page might appear providing a text field for the software user to enter a summary label. The summary label is what will appear in a column header of a table such as the Recurring (or OnGoing) form table illustrated in FIG. 5.

In some example embodiments, other functionality (including configuration of variables ability) that can be implemented within the question modifying page(s) of the form manager tool include the following:

Header—for data export purposes: what will appear at the top of Excel® and SPSS columns.

Description—for data export purposes as well: what will appear in SPSS as a description for the column header. The export description is commonly a copy of the question text.

Answer—permits the software user to enter a list of possible responses (up to a character limit, e.g. 100) if the question type selected was ‘Single’ or ‘Multiple’ answer-type.

Preview—display a preview of how the answer entry will appear in the form.

In the case of Single Answer and Multiple Answer questions, it may be desirable to provide the form completing entity with the option of providing an ‘Other’ Answer (e.g. in order to permit more flexibility in answering the questions). One skilled in the art will appreciate that this is typically done by providing a text field next to the ‘Other’ radio button. Subsequent to a form completing entity entering text in the text field, the entered text appears in a separate, adjoining column in the export. Therefore there will be a unique header and description for ‘Other’ Answers.

The table below shows example data as it might appear in an Excel® export.

| SubjectID | Mood | FeelOthr |
|---|---|---|
| 01-1-LK | Other (please specify) | Anxious |

Here the ‘Other’ text entered is “Anxious”.

In at least certain instances of some embodiments, the software user will associate each of the possible answers of a Single Answer type question with a numeric value. In this manner, the answer provided by the form completing entity can be used in calculating some value. As an example of association of answers with numeric values, daily could be associated with the value 1, weekly could be associated with the value 7 and monthly could be associated with the value 30.

Just as in the case of Single Answer type questions, it is possible for the software user to be given the ability to associate each of the possible answers of a Multiple Answer type question with a numeric value. Since multiple answers can be selected, it may be appropriate for the sum of all answers to be the value used when this type of question is selected as part of a formula.

If it is decided to have image embedded answers in a form, one or more questions can be designated to receive answer(s) selected in the image. This designated question(s) would be “Hidden by Default” since the image having the embedded answers would normally display the selected answer(s). The purpose of the hidden question(s) is simply to “capture” the number as selected by the form completing entity that interacts with the image presented in the form.

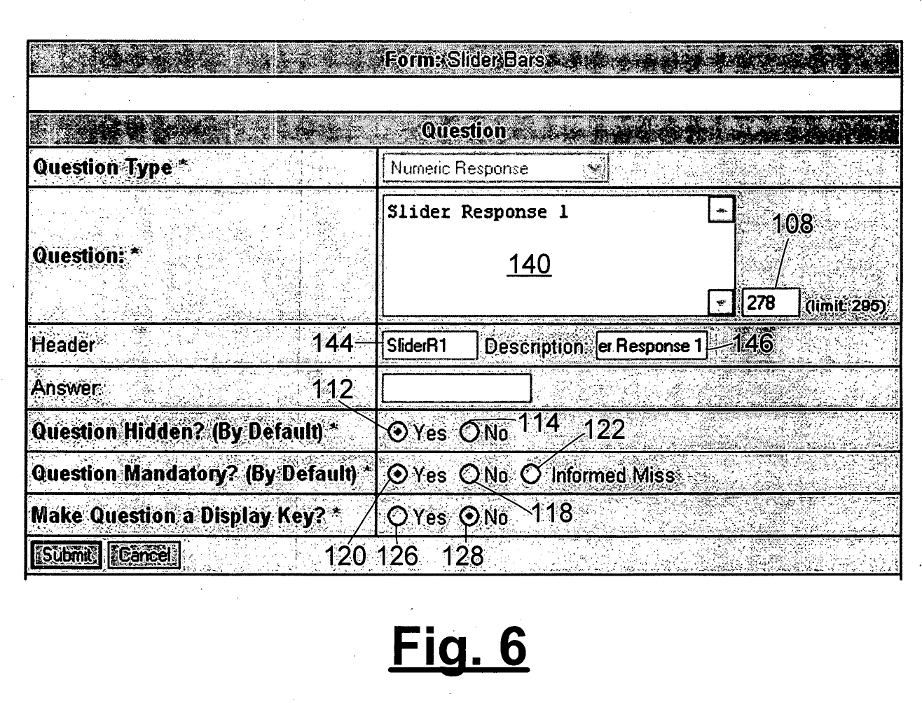

FIG. 6 is a screen shot of the same form designer page illustrated in FIG. 4, but configured to create a hidden question associated with a slider bar image. In question text field 140 the text “Slider Response 1” has been entered, which is descriptive of what the question is doing. “Slider R1” has been entered as the header in text field 144. Text field 146 contains the same text as the text field 140. Also, the question has been set as hidden by default and mandatory by default.

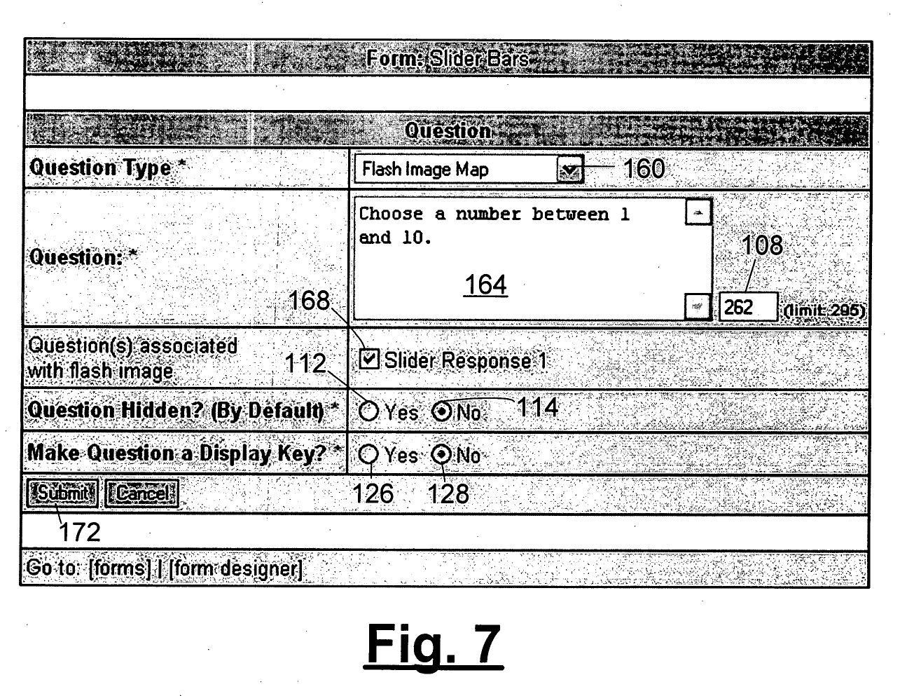

Continuing with the example, a question will be created that will contain the image itself. FIG. 7 is a screen shot of the same form designer page illustrated in FIG. 4, but configured to create a question that will contain the flash image itself. Question type “Flash Image Map” has been selected using drop-down selector 160. In text field 164, the text, “Choose a number between 1 and 10”, has been entered. In the form that would be generated in connection with this example, the text in the field 164 would be the text of the question presented to the form completing entity during form completion. Check box 168 has been checked, indicating that the question “Slider Response 1” is associated with the flash image.

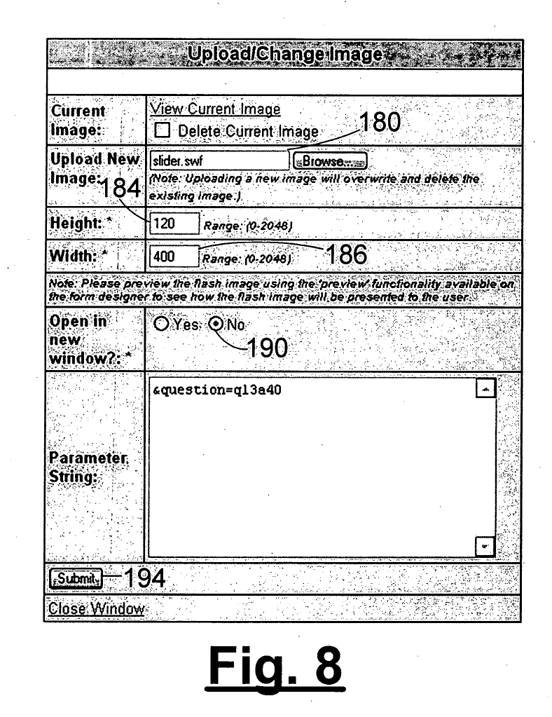

When ‘Submit’ button 172 of the illustrated page is clicked, a new page can appear. Such a page in accordance with an example embodiment is illustrated in FIG. 8. A purpose of the page is to assist the software user in uploading and connecting the image in order to function within the form as intended. Present in text field 180 is the name of the file (filename) containing the image. Height and width (in pixels) of the image to be displayed has been entered in text fields 184 and 186 respectively. ‘No’ radio button 190 has been selected to indicate that the image will not be opened in a different window than the window of the form. When ‘Submit’ button 194 of the illustrated page is clicked, a new screen can appear describing the status and/or changes made.

The image itself might not be created by the same person as the software user. The table below lists example API information that might be provided to the person contracted or otherwise tasked to create the image.

API Information

| | | | | Has | |
|---|---|---|---|---|---|
| Question | Question | Answer | Answer | Other | |
| ID | Text | ID | Text | Text | Example |
| 13 | Slider | 40 | | N | q13a40 = [numeric |
| | Response 1 | | | | value] |

### DUPLICATION/PROPAGATION OF QUESTIONS

In one embodiment, the form designer tool allows the software user to perform duplication related actions on an existing question. In one example aspect, the software user can copy a question and its properties from one form to another. The copied question might include an exact duplicate of the export headers answer options, and text from the original, but might not include any related events and formulas. Unless otherwise clear from the context, subsequent references to duplication of questions herein are references to this example aspect. In another example aspect, in addition to question properties being duplicated from one form to another, the software user can also copy a form completing entity's answer from a previous form to the current one. Unless otherwise clear from the context, subsequent references to propagation of questions herein are references to this example aspect.

If the duplicated question contains an exact copy of the export headers and descriptions from the original question, the export headers for each question will need to be changed to avoid duplicate headers existing within the database preventing exporting of the project. It will be understood that the export headers (in an embodiment having appropriate additional handing code) could be changed automatically without the software user needing to remember to change them himself.

Propagation of questions is practical where the answer entered in a previous form is important in determining the answers in the current form. It may also be used to perform actions or validation based on the answer in a previous form. As an example, there could be the desire to propagate a form completing entity's answer to a “Gender” question from a Demographics form in order to determined whether all questions relating to pregnancy on a subsequent form should be hidden.

When propagating a question from a previous form, the software may need to select a visit that the propagated value should be taken from. The options available will vary depending on the form type that is being copied from and the form type that is being copied to. The table below represents, for one example implementation, the possible choices depending on the source and destination:

| | Destination | | |
|---|---|---|---|
| Source | Single | Recurring | OnGoing |
| Single | First Visit | First Visit | First Visit |
| | Previous Visit | Previous Visit | Most Recent Visit |
| | | Current Visit | |
| Recurring | First Visit | First Visit | First Visit |
| | Previous Visit | Previous Visit | Most Recent Visit |
| | Current Visit | Current Visit | |
| | | Most Recent- | |
| | | Recurring | |
| OnGoing | First Instance | First Instance | First Instance |
| | Most Recent Instance | Most Recent | Most Recent |
| | | Instance | Instance |

Thus, the table above reveals that the possible choices vary quite significantly, for the example implementation, depending on the source and destination. With respect to the First Visit choice, the first instance of the form (e.g. as identified by group, visit and form) will act as a ‘master form’ in which data can be propagated to forms in the current or subsequent visits. With respect to the Previous Visit choice, the source of the propagation will be the visit (in sequence) prior to the current visit that has an instance of the form. With respect to the Most Recent Visit choice, the source of the propagation will be the latest, most recent instance of the form in the current visit. With respect to the Most Recent-Recurring choice, the source will be either the most recent instance of the form in this current visit or, if this is the first instance of this recurring form in this visit, the most recent instance of the form from the previous visit. With respect to the First Instance choice, the source of this propagation will be the first instance of this OnGoing form. With respect to the Most Recent Instance choice, the source of the propagation will be from the most recent instance of this OnGoing form, by creation date.

It will be understood that changes to a value that is propagated to other forms can have a far ranging impact. One problem with allowing a changed value to propagate automatically to the other forms could be, for example, a situation where one or more events uncover hidden, mandatory questions. If such a situation occurred, one or more forms would be incomplete, or contain answers to questions that should not have been asked. Therefore, it may be important to design the software such that if a change to a “master form” is made, each of the subsequent, affected forms would have to be resubmitted to make the changes in those forms. Also, it may be practical for the software user to be notified of which destination forms will be affected by this change when a source question is changed. In addition, it may be useful for the software user to be alerted when editing a destination form containing answers that have been changed at the source.

Questions that have values propagated to another form and questions that have values propagated from another form can, in one embodiment, be tracked with the tracking information accessible to the software user. The ‘[info]’ link 94 shown in FIG. 3 is an example of a convenient way in which the software user can access the tracking information. The ‘[info]’ link 94 will be in either the “Copied” column, the “Copy” column, or both. “Copied” refers to the fact that this question has its value “copied” or propagated. “Copy” refers to the fact that this value will be a “copy” or propagated from another form.

In one embodiment, questions that propagate values to other forms may not be deleted until all destination questions have first been deleted. The software user can determine which destination questions must first be deleted by clicking the appropriate ‘[info]’ link displayed in the “Copied” column.

### EVENT RESPONSES

Events can trigger actions (responses) within a form. The loading of a form, a form completing entity entering information into a form, and the submission of a form are examples of possible events. Actions following events may, in some example embodiments, include showing and hiding questions, executing formulas, validating data, etc.

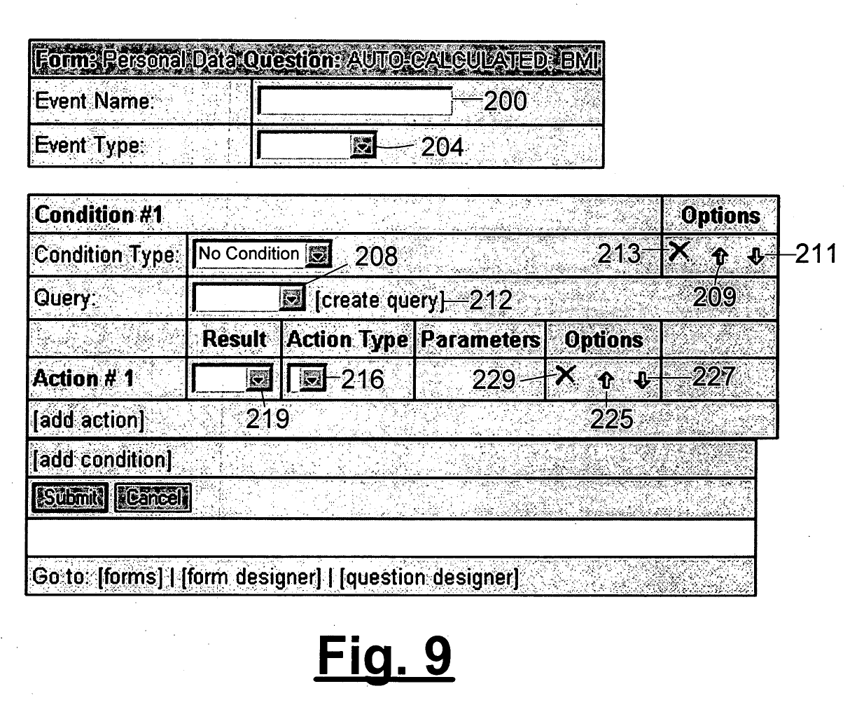

FIG. 9 is a screen shot of an example page of medical form software within which event responses can be created. In the illustrated page, text field 200 is provided for the software user to enter a descriptive name that helps identify the function of the event response. Drop-down selector 204 permits the software user to select the type of event response from a drop-down list. Three example types of event responses that can be created, in some example embodiments, include the following:

| Event Response Type | Description |
|---|---|
| onLoad | This type of event response is executed immediately when the form |
| | is first loaded. |
| | Sample uses: |
| | To make a calculated field ReadOnly |
| | To check if a patient is eligible to enter form |
| | To make certain questions Mandatory depending on previously |
| | entered information |
| | To ensure a previous form has been filled out before allowing the |
| | form completing entity to enter information |
| onChange | This type of event response (typically a conditional response) is |
| | executed only when an answer to the question that the event |
| | response was added to has been changed. |
| | Sample uses: |
| | Show or hide other questions in the form based on the response to |
| | the question |
| | Pop up a message depending on response selected |
| | Warn the form completing entity if the entered value is out of range |
| | Execute a calculation whose result is displayed in the form |
| onSubmit | This type of event response is executed only when the form is |
| | submitted. |
| | Sample uses: |
| | Execute a calculation whose result is hidden from the form |
| | completing entity (“Hidden by Default” question) |
| | Exclude a patient from the study based on their answers to |
| | questions |
| | Prevent a form completing entity from being able to submit their |
| | data if they have entered values that are out of range |

An event response can be based on one or more conditions. A condition could be said to mean, “Run the following actions depending on the result of this query.” Where there is more than one condition listed in a page similar to the one illustrated in FIG. 9, ordering of the conditions can be changed using the buttons 209 and 211. The button 209 moves a condition up in the list, whereas the button 211 moves a condition down in the list. Button 213 deletes a condition.

It will be understood that a query returns either TRUE or FALSE based on the expressions being queried. Which actions are executed is based on the end result of the query. In some example embodiments, if the result of the selected query is TRUE then all actions set with Result=TRUE are run. Conversely, if the result of the selected query is FALSE then all actions set with Result=FALSE are run. For the illustrated example, whether the action is run on Result=TRUE or Result=FALSE can be set using drop-down selector 219.

If, in the illustrated page, “No Query” is selected, then Result=TRUE actions are always executed when the event is triggered. Otherwise a particular query can be selected using drop-down selector 208, or a new query could be created and then subsequently selected. ‘[Create query]’ link 212 is provided for creating a new query.

In the illustrated example, a particular action type can be selected by the software user using drop-down selector 216. Examples of action types are listed in the table below.

| Action Type | Description |
|---|---|
| Show a question | This shows one or more questions in a form set to “Hidden by Default” or |
| | that were hidden by a previous event response. |
| Hide a question | This hides one or more questions in a form that appear by default within |
| | the form or were shown by a previous event response. |
| Pop up a message | This allows the software user to enter a short message that will pop up on |
| | the screen. |
| Set a question to | This sets one or more questions so that data cannot be entered into the field |
| ReadOnly | by the form completing entity (it does not, however, prevent a value from |
| | appearing using formulas). |
| Set a question to | This sets one or more questions previously set to ReadOnly so that the field |
| Writeable | can be modified by the form completing entity. |
| Set a question to | This sets one or more questions so that an answer is not required to submit |
| Optional | the form. |
| Set a question to | This sets one of more questions so that an answer is required to submit the |
| Mandatory | form. |
| Set a question to | This sets one or more questions so that an answer is not required to submit |
| Informed Miss | the form, but a warning will appear if the field was left blank by the form |
| | completing entity. |
| Invalidate | Preferably only functional when used with “onSubmit” event responses. |
| | This prevents the form completing entity from submitting the form. This |
| | type of action is commonly used to prevent the submission of a form if the |
| | form completing entity has entered a value that is out of range. |
| Patient Ineligible | Preferably only functional when used with “onLoad” event responses. This |
| for Form | prevents the form completing entity from being able to enter the form. |
| | This action type allows the software user to enter text to be displayed in a |
| | pop up message to the form completing entity. This type of event is |
| | commonly used to prevent an excluded form completing entity from being |
| | able to enter a form or enforce an order of form entry. |
| Set Patient Status | Preferably only functional when used with “onSubmit” event responses. |
| | This allows the software user to set the status of a subject to one of the |
| | following settings: |
| | Excluded |
| | Included |
| | Withdrawn |
| | Study Completed |
| | Setting a patient status is commonly used to control access to forms. |

Where there is more than one action listed in a page similar to the one illustrated in FIG. 9, ordering of the actions can be changed using the buttons 225 and 227. The button 225 moves an action up in the list, whereas the button 227 moves an action down in the list. Button 229 deletes an action.

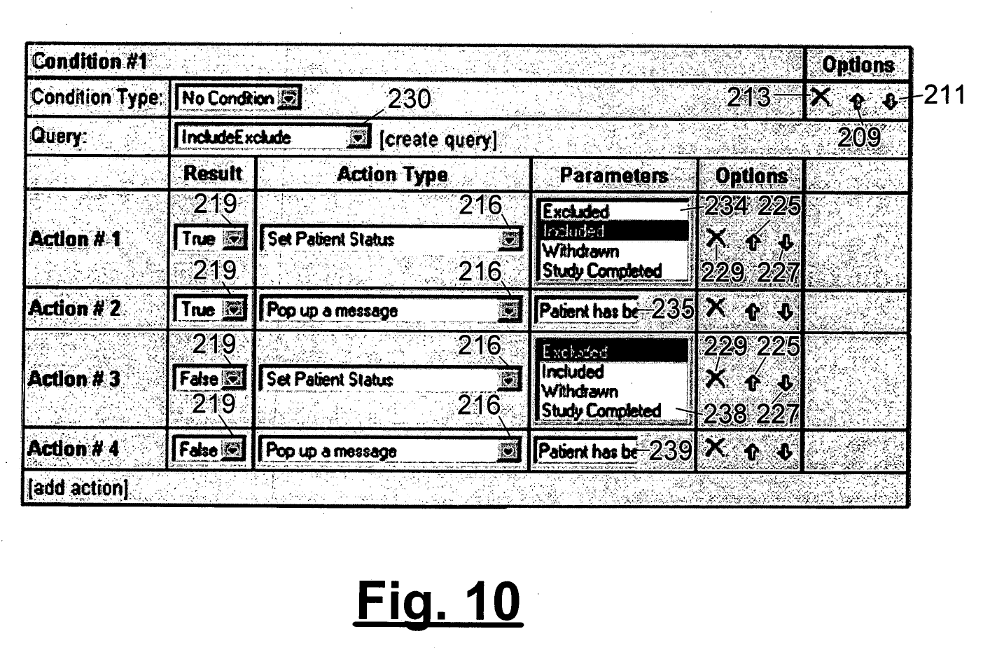

FIG. 10 is a screen shot of a portion of the page of FIG. 9, but substantially completed. The software user has built an onSubmit event response in relation to whether a patient will be included or excluded.

In the illustrated example, the software user has selected IncludeExclude query to be run using drop-down selector 230. Referring to Actions 1-4, if the IncludeExclude query result is TRUE (i.e. the inclusion criteria was met), then when the form is submitted Action #1 will set the patient's status to “Included” (note that “Included” has been highlighted in selection field 234), and Action #2 will pop up a message telling the patient (text in field 235) that they have been included in the trial. If the query result is FALSE (i.e. the inclusion criteria was not met), then when the form is submitted Action #3 will set the patient's status to “Excluded” (note that “Excluded” has been highlighted in selection field 238), and Action #4 will pop up a message telling the patient (text in field 239) that they have been excluded from the trial.

In one embodiment, an event needs to occur for a formula to be executed. The formula will be executed differently depending up on whether it is associated with an onchange or an onSubmit event response. In the case of the onchange event response, when the form completing entity enters a value in a question, the formula is executed. Also, typically event responses will be added to every question in the form that is used in the formula. In the case of the onSubmit event response, the formula is executed only when the form is submitted. This alternative approach is practical if the question containing the calculated value is “Hidden” and therefore cannot be seen by the form completing entity. For the onSubmit event response approach, only one event response is needed to execute the formula.

In a number of situations it will be desired to verify the data that is entered in a form. For example, a question might be, “Please enter a number on a scale of 1 to 10.” An onSubmit event could be created to verify the data, and if the number entered is outside of the range of 1 to 10, prevent the form completing entity from being able to submit the form. A first step in doing this could be to build a query in relation to the form completing entity's submitted Answer (Answer1). The query could be as follows: if Answer1 is less than 1 or if Answer 1 is greater than 10. If the result of this query is TRUE (i.e. the value is not between 1 and 10) then, when the form is submitted, a condition fulfilled action could be taken to ensure the form completing entity is not allowed to submit the form, and a customized pop-up message could appear informing the form completing entity “A number between 1 and 10 must be entered.” If the result is FALSE, then the form completing entity will not be prevented from submitting the form.

In some example embodiments, a common use of event responses is to show or hide questions based on the answer to a previous question. This allows the “cascading” of questions and is practical to help ensure only the relevant questions are available to answer.

For example, it might be desired to have a form including the following two questions:

1. “Has the patient smoked in the last 3 months?”

2. How many cigarettes has the patient smoked in the last 3 months?”

In this scenario, the second question would only need to be asked if the answer was “Yes” to the first. If the answer is “No”, the second question remains hidden because there would be no need to show it to the form completing entity.

### EVENT RESPONSES IN THE CONTEXT OF PROPAGATION OF QUESTIONS

Where applicable, a particular form's integrity may be improved by having all event responses relating to a propagated field's contents executed onchange. Also, it may be necessary to use an event response to make certain populated fields “ReadOnly” to ensure that a value such as the patient's gender cannot be changed anywhere except in the master form.

### QUERIES

In one embodiment, a query is built by the software user for one of the following two purposes:

1. A query is built so that it can act as a filter, allowing the selecting out of specific data that meets intended criteria when generating reports.

2. A query is built so that it can run in conjunction with form event responses. In this case, the query allows testing of one set of criteria against another.

In some example embodiments, the graphical user interface (GUI) of the software can permit the software user to construct queries based on multiple expressions. The following table lists four types of components in a query.

| Component | Description |
|---|---|
| Left Operand | This is the first value that is to be compared to a |
| | Right Operand. |
| Operator | This specifies how the first value will be |
| | compared to the second. |
| Right Operand | This is the second value that is compared to the |
| | Left Operand. This could potentially be a |
| | number, text value, answer, or a question |
| | depending on which Left Operand is selected. |
| Conjunction | This links multiple expressions together. |
| | For example, is (Expression 1 and Expression |
| | 2) or (Expression 3) true? |

In one example embodiment, when the software user first loads the page associated with building queries, he is able to select from the following eight different types of Left Operands from which to create an expression:

| Left Operand | Comment |
|---|---|
| Question | Typically selected when it is desired to test the answer of a question to |
| | another value. Example: |
| | if answer to “Q1-What is your sex?” equals “Female” then perform an |
| | action or display data |
| SubjectFilledForms | Typically selected if it is desired to query based on whether the current |
| | subject has filled out a particular form. Example: |
| | if SubjectFilledForm “Screening” then perform an action or display |
| | data |
| SubjectStatus | Typically selected if it is desired to perform an action based on the |
| | current status of the subject. Example: |
| | if SubjectStatus equals “Excluded” then perform an action or display |
| | data |
| Subject | Typically selected if it is desired to query based on an individual |
| | subject. This is useful when it is desired to create a report using the |
| | data from one specific subject. Example: |
| | if subject equals “01-01-NS-01” then display data |
| Center | Typically selected if it is desired to query based on an individual |
| | center. Example: |
| | if Center equals “General Hospital” then perform an action or display |
| | data |
| Group | Typically selected if it is desired to query based on an individual |
| | group. Example: |
| | if Group equals “Leukemia Patients” then perform an action or display |
| | data |
| Visit | Typically selected if it is desired to query based on an individual visit. |
| | Example: |
| | if Visit equals “Screening Visit” then perform an action or display data |
| SubjectCreationDate | Typically selected if it is desired to query based on the date that the |
| | subject was created in the system. Example: |
| | if SubjectCreationDate is less than “Jan 1^{st}, 2005” then perform an |
| | action or display data |

The possible options of what type of Right Operand can be used in an expression varies based on what type of Left Operand was selected. For example, a Center Left Operand might only be allowed to be tested against the name of a Center.

The table below lists, for query building in accordance with an example embodiment, possible Right Operands and possible Operators for various Left Operands:

| Left Operand | Possible Right Operands | Possible Operators |
|---|---|---|
| Question: | Answer Type: Allows the | ==, != |
| Single Variable | software user to select a | |
| Answer | specific answer from the | |
| Multiple Variable | question that was selected as | |
| Answer | the Left Operand. | |
| | Question Type: Allows the | |
| | software user to compare the | |
| | Left Operand to the answer of | |
| | another question. | |
| Question: Numeric | Number | ==, !=, >, <, >=, <= |
| Question: Text | String | ==, != |
| Question: Date | Question Type | =, !=, >, <, >=, <= |
| Center | Select from a list of Centers | ==, != |
| Group | Select from a list of Groups | ==, != |
| Visit | Select from a list of Visits | ==, != |
| Subject | Select from a list of Subjects | ==, != |
| SubjectFilledForms | Select from a list of Forms | ==, != |
| SubjectCreationDate | Select a date from a pop-up | |
| | calendar. | |
| SubjectStatus | Select from a list of statuses: | ==, != |
| | Included, Excluded, | |
| | Withdrawn, Study Completed | |

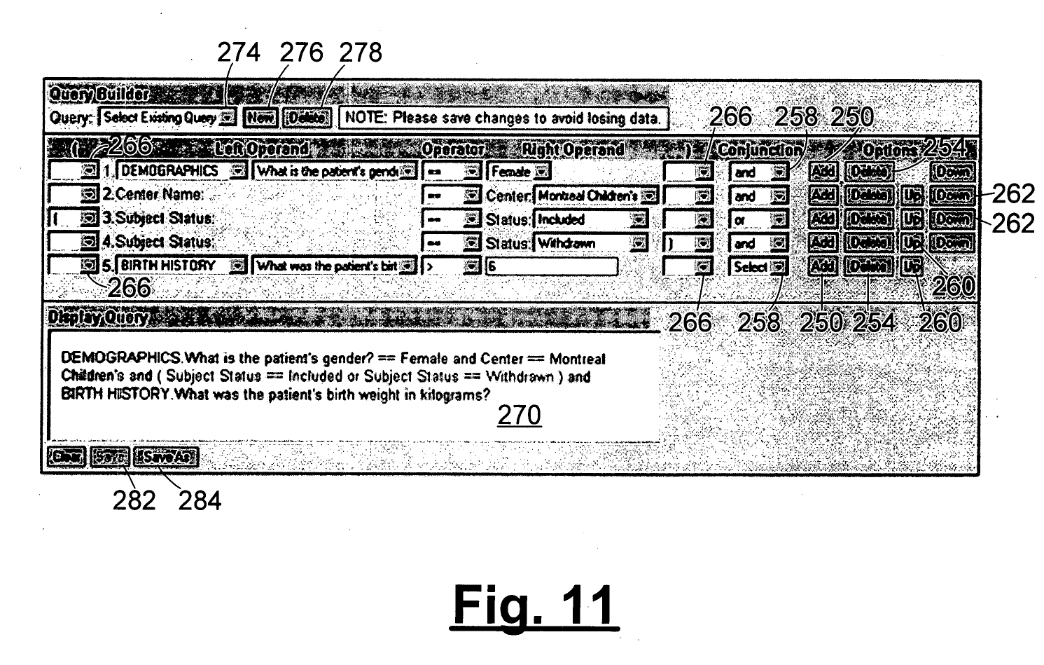

FIG. 11 is a screen shot of an example page within which an example query is being built for all Females at the Montreal Children's Hospital that have been Included or Withdrawn but whose birth weight was over 6 pounds. This query could be written as follows: if “Q 1 —What is the patient's gender?” equals Female and if Center equals “Montreal Children's” and (if SubjectStatus equals Included or if Patient Status equals Withdrawn) and if “Q2—What was the patient's birth weight?” is greater than 6.

Within the example page shown in FIG. 11, the software user adds or deletes an expression by clicking the ‘Add’ button 250 or the ‘Delete’ button 254 that is to the right of the intended expression. Drop-down selector 258 is left in its default text ‘Select’ when the software user does not intend to use a conjunction to add an additional expression. The order of expressions can be changed by clicking ‘Up’ buttons 260 or ‘Down’ buttons 262.

Drop-down selectors 266 that are provided within the illustrated page can be used to add brackets within the query. Adding brackets permits specifying which expression comparisons should be performed first.

“Display Query” area 270 is also provided within the illustrated page. Expressions are displayed within the area 270 as they are built, in the form of a text, mathematical equation.

In the illustrated example, an existing query can be selected using drop-down selector 274. A new query can be created by clicking button 276. If the software user wishes to delete a previously built query, he can do so by selecting that query using the drop-down selector 274 and then clicking on delete button 278. Modified or newly created queries can be saved by clicking on either button 282 or button 284.

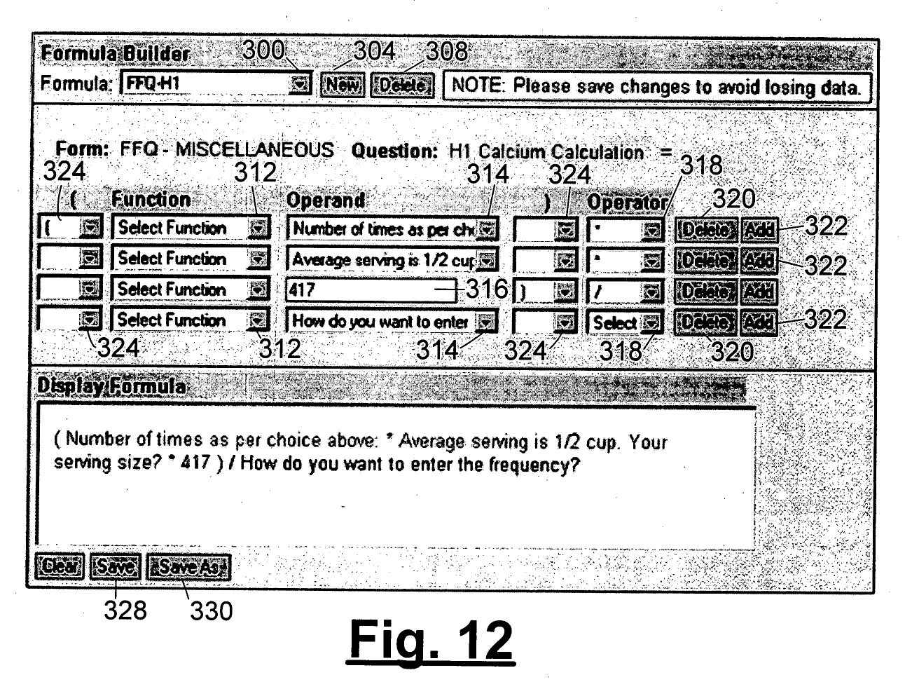

FIG. 12 is a screen shot of an example page in accordance with an example embodiment of the medical form software. Within the illustrated page, the software user can create and modify formulas which will insert a calculated value into the answer of a Numeric-type question within a form. Furthermore, the software user can construct formulas based on multiple expressions. In the illustrated embodiment, each expression can include one or more of the following three components:

| Component | Comment |
|---|---|
| Function | The function performed on the Operand |
| Operand | The value that the function or operator acts |
| | upon |
| Operator | A mathematical operation that is performed on |
| | one expression with the expression that follows |

With respect to functions, possibilities include those listed in the following table:

| Function | Description |
|---|---|
| Sq | Performs a ‘square’ calculation on the operand. |
| Sqrt | Performs a ‘square root’ calculation on the operand. |
| zerolfUnanswered | If the operand is a Question Type (as opposed to a Constant |
| | Numeric Type) and has not been answered, the value of zero (0) |
| | will be used for the operand value. |
| Math.round | Round the operand(s) to the nearest whole number. |
| daysInDate | Convert the operand in a date calculation to number of days. For |
| | example, if the software user wanted to calculate the number of |
| | days between two date questions called “Start Date” and “End |
| | Date” this function would be used. |
| yearsInDate | Convert the result of a date calculation to number of years. For |
| | example, if the software user wanted to calculate the age of a |
| | person based on their birth date and the current date, this function |
| | would be useful. |
| currentDate | Replace the operand with the current date. |
| firstFilledDate | Replace the operand with the date that the subject first began to fill |
| | out the current form if it is being edited. If this is the first time the |
| | form is being filled out this date will be the current date. |
| subjectCreationDate | Replace the operand with the current date. |
| multiplyToDays | When a constant number is added to a date calculation, this |
| | function converts the constant into a “day”. This function could be |
| | useful in conjunction with the calculation of due dates. |
| multiplyToYears | When a constant number is added to a date calculation, this |
| | function converts the constant into a “year”. |
| hoursInDate | Convert the operand in a date calculation to number of hours. For |
| | example, this function could be used to calculate the number of |
| | hours since the patient first made an entry in a form. |
| minutesInDate | Convert the operand in a date calculation to number of minutes. |

With respect to operand categories (types) in the context of formulas, possibilities include those listed in the following table:

| Operand Category | Comment |
|---|---|
| Question Type | If the Question-type is Numeric, the value entered as |
| | the answer will be used. |
| | If the Question-type is a Single-Answer Variable, |
| | the numeric value assigned by the software user to the |
| | answer will be used. |
| | If the Question-type is a Multiple-Answer Variable, |
| | since multiple answers can be selected, |
| | the sum of all numeric values assigned by the |
| | software user to all selected answers will be used. |
| Constant Numeric | Allows the entry of a fixed value. |
| Type | |

Within the example page shown in FIG. 12, the software user can load an existing formula by selecting it using drop-down selector 300. A new formula can be created by clicking on button 304. Also, an existing formula can be deleted. First, the software user would select the formula using the drop-down selector 300, and then he would click button 308.

Also within the example page, drop-down selectors 312 permit the selecting of a function for a particular expression. Drop-down selectors 314 permit the selection of an operand for a particular expression, or a constant can be typed in as shown in text field 316. Drop-down selectors 318 permit the selecting of an operator for a particular expression. Buttons 320 permit deletion of an expression, whereas buttons 322 permit addition of an expression. Brackets can be added to the formula using the drop-down selectors 324. (Naturally the values of expressions within brackets will be calculated first). A created or modified formula can be saved by clicking on either button 328 or button 330.

### GROUP MANAGEMENT

In those embodiments in which there exists a group level, the medical form software might include a tool permitting the software user to perform actions for managing the groups, including adding a group, deleting a group, modifying a group and ordering a group. Also, if there is a center level above the group level, the software user might be provided with the ability to associate certain groups with only one, or only some of the possible centers.

### VISIT MANAGEMENT

In those embodiments in which there is a visit level, the medical form software might include a tool permitting the software user to perform management actions in relation to visits, such as adding a visit, deleting a visit, modifying a visit and ordering a visit. Types of possible visits could include a single visit (meaning that the visit only occurs once) and a recurring visit (meaning that the visit can occur multiple times). With the visit tool, the software user would typically be able to associate visits with some higher hierarchical levels above it (e.g. center, group) but not others (e.g. subject).

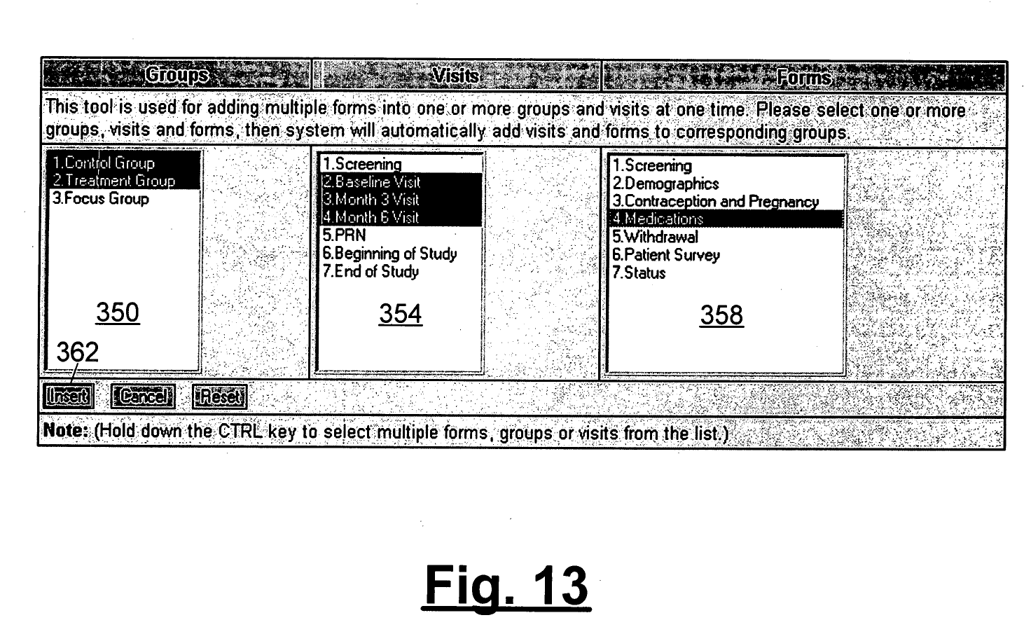

In some example embodiments, the user interface of the medical form software includes pages within which multiple levels can be reviewed and managed at once. FIG. 13 is a screen shot of an example management page within which a “Medications” form is being added to multiple visit across multiple groups. The software user in this example has highlighted the applicable groups in selection field 350 and visits in selection field 354 to which the form that was highlighted by the software user in selection field 358 will be copied to once he clicks on insert button 362.

### TREE OF REPORTS

In some example embodiments, the software user is given the ability to build an expandable tree of reports. In one of these embodiments, each report in the tree is a small report providing the number of unique records that have met the criteria of a specified query. At any level in the tree, there will be one or more reports. Any of these reports might have one or more children reports which would be in a level below that report. Where each of the reports in the tree is essentially a number, the values of the children reports might add up to the value of the associated parent report. In addition to the possibility of children reports being associated with a parent report, it will be understood that a child report could itself have one or more children reports.

Where all the reports in an expandable tree of reports are each essentially a reported number, associated reports could be combined in a graph to facilitate reporting. Pie charts and/or bar charts would typically be selected for graph portions of reporting. It will be understood that produced graphs could be captured and used in a variety of different documents.

While the invention has been described in conjunction with example embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims.

What is claimed is:

1. A computer program product having a computer readable medium storing medical form software that provides a user interface, the medical form software comprising:
computer executable instructions for creating at least partially non-completed medical forms, each of said medical forms defined at least in part by a plurality of operands, a number of said operands modifiable upon form completion by a form completing entity; and
computer executable instructions for building, within said user interface, conditional responses to potential future events occurring in relation to said medical forms.

2. A computer program product as claimed in claim 1, wherein said user interface is a graphical user interface (GUI).

3. A computer program product as claimed in claim 1, further comprising computer executable instructions for building queries within said user interface.

4. A computer program product as claimed in claim 2, wherein said user interface permits a user of said medical form software to select particular queries to be run in conjunction with said potential events.

5. A computer program product as claimed in claim 4, wherein said user selects a query to be run in conjunction with one of said potential events by using a drop-down selector.

6. A computer program product as claimed in claim 2, further comprising computer executable instructions for building a formula to carry out a mathematical operation whose result is displayable within the medical form.

7. A computer program product as claimed in claim 1, wherein at least one of said plurality of operands is intended to have a value selected from one of Yes and No, and said operand is associated with a question.

8. A computer program product as claimed in claim 7, wherein if said form completing entity selects one of said intended values, certain questions in a particular form will become hidden, and if said form completing entity selects the other value, said certain questions will not be hidden in said particular form.

9. A computer program product as claimed in claim 1, wherein at least one of said medical forms is specific to a certain type of medical illness.

10. A computer program product as claimed in claim 1, wherein said form completing entity is a subject, said subject permitted access to a number of said medical forms if one of said operands indicates said subject is included in a medical study.

11. A computer program product as claimed in claim 1, wherein said medical forms include access settings.

12. A computer program product as claimed in claim 11, wherein said access settings can vary depending upon subject, said form completing entity provided a selected one of the following levels of access: read, read and write, and no access.

13. A computer program product as claimed in claim 6, wherein some of said operands effect said result of the mathematical operation.

14. A computer program product as claimed in claim 1, wherein said medical forms include at least a selected one of a screening form, a demographics form, a medications form, and a withdrawal form.

15. A computer program product as claimed in claim 1, wherein said medical forms can include forms in each of the following categories: single, recurring and ongoing.

16. A computer program product as claimed in claim 4, wherein said user interface further permits said user to freeze and unfreeze said medical forms.

17. A computer program product as claimed in claim 1, wherein said medical forms are clinical trial forms.

18. A method carried out on a computer system having at least one user input device and at least one computer readable medium storing medical form software, the method comprising the steps of:
operating said at least one user input device to generate a plurality of commands recognized by said software to create at least partially non-completed medical forms, each of said medical forms defined at least in part by a plurality of operands, a number of said operands modifiable upon form completion by a form completing entity; and
building, within said user interface, conditional responses to potential future events occurring in relation to said medical forms.

19. A method as claimed in claim 18 wherein the method is carried out by an individual other than a software professional.

20. A method as claimed in claim 18 further comprising the step of building queries within said user interface.

21. A method as claimed in claim 18 wherein said user interface is a graphical user interface (GUI).

22. A method as claimed in claim 21 wherein the step of building conditional responses includes selecting particular queries to be run in conjunction with said potential events.

23. A method as claimed in claim 18 further comprising the step of building a formula to carry out mathematical operation whose result is displayable within the medical form.
